(19) United States
(12) Patent Application Publication
(10) Pub. No.: US 2017/0061126 A1
(43) Pub. Date: Mar. 2, 2017

(54) Process Launch, Monitoring and Execution Control

(71) Applicant: Nehemiah Security, Tyson's Corner, VA (US)

(72) Inventor: David Eugene HOOKS, Cary, NC (US)

(21) Appl. No.: 15/255,806

(22) Filed: Sep. 2, 2016

Related U.S. Application Data
(60) Provisional application No. 62/213,329, filed on Sep. 2, 2015.

(51) Int. Cl. G06F 21/56; G06F 21/55

(52) U.S. Cl. CPC G06F 21/566; G06F 21/552

(57) ABSTRACT

One or more computer processes executing on a client computer are monitored for an anomalous condition relative to an adaptive reference model of the client computer. In response to detecting the anomalous condition, information is gathered regarding the anomalous condition as the processes continue to execute. A score is computed indicating a risk for continued execution of each of the processes based on the gathered information. Any of the processes for which the corresponding risk score meets a predetermined continued execution risk criterion is terminated.

### RELATED APPLICATION DATA

This application claims the benefit of priority of U.S. Provisional Patent Application No. 62/213,329 filed on Sep. 2, 2015, the entirety of which is hereby incorporated by reference.

### BACKGROUND

Conventional computer security products use two approaches for blocking execution of malicious files, i.e., blacklisting and whitelisting. The blacklisting approach is used by anti-virus applications; it compares executable files stored on a computer to a list of known malicious files, typically through file signature analysis. The primary advantage of this approach is that it identifies malicious files and prevents execution of those files very quickly and with a high degree of confidence. The disadvantage of blacklisting is that it is relatively easy to circumvent, such as by changing or obscuring the malicious file signature to prevent matching an entry in the blacklist.

The whitelisting approach compares the executable files to a list of trusted processes corresponding to the executable. Unless the signature of the executable file appears on the whitelist, then the corresponding process is not allowed to execute. The advantage of this approach is that it effectively blocks most types of malware. The primary disadvantage is that whitelists tend to be very large and need to change frequently. This creates a prohibitive administrative burden, especially with respect to computing environments, e.g., workstations, where there are tens of thousands of legitimate processes and applications.

Current endpoint defense techniques rely heavily on anti-virus products that block the execution of malware files based on a large, constantly evolving blacklist. Based on data found in various technical journal articles and the inventor's own experience, these techniques are only about 30% effective against new malware. It is desirable to detect and block a much higher percentage of new threats.

The administrative burden imposed by whitelisting tools limits their application to servers and computing environments that can tolerate complete lockdown. It would be desirable to leverage whitelisting concepts without the administrative overhead.

It is possible to inject malware code into a legitimate process without storing a file in memory. None of the existing endpoint security tools address this problem in an effective way.

### SUMMARY

One or more computer processes executing on a client computer are monitored for an anomalous condition relative to an adaptive reference model of the client computer. In response to detecting the anomalous condition, information is gathered regarding the anomalous condition as the processes continue to execute. A score is computed indicating a risk for continued execution of each of the processes based on the gathered information. Any of the processes for which the corresponding risk score meets a predetermined continued execution risk criterion is terminated.

### BRIEF DESCRIPTION OF THE DRAWINGS

FIG. 1 illustrates an exemplary environment in which an embodiment of the present invention may operate.

FIG. 2 is a schematic diagram of information flow in embodiments of the present invention.

FIG. 3 is a schematic flow diagram of a process control technique by which the present invention can be embodied.

FIG. 4 is a flow diagram of a process control technique by which the present invention can be embodied.

### DETAILED DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

The figures described herein include schematic block diagrams illustrating various interoperating functional modules. Such diagrams are not intended to serve as electrical schematics and interconnections illustrated are intended to depict signal flow, various interoperations between functional components and/or processes and are not necessarily direct electrical connections between such components. Moreover, the functionality illustrated and described via separate components need not be distributed as shown, and the discrete blocks in the diagrams are not necessarily intended to depict discrete electrical components.

The techniques described herein are directed to automated computer support, particularly to runtime process monitoring and execution control. Certain embodiments of the present invention utilize functional components and methodologies described in U.S. Pat. No. 7,593,936 (the “'936 patent”), U.S. Pat. No. 8,104,087 (the “'087 patent”) and U.S. Pat. No. 8,984,331 (the “'331 patent”), all of which are hereby incorporated by reference in their respective entireties and are collectively referred to herein as the “reference system documentation.” Upon review of this disclosure and appreciation of the concepts disclosed herein, the ordinarily skilled artisan will recognize other process monitoring and execution control contexts in which the present inventive concept can be applied. The scope of the present invention is intended to encompass all such alternative implementations.

The present invention decreases whitelisting administrative overhead by automatically learning the prevalence of an executable file as indicator of its risk level. By combining this information with other risk measures, embodiments of the present invention automatically block the execution of many harmful files without any human involvement.

Additionally, the present invention detects malicious behavior and/terminates processes that have been compromised, including legitimate processes that are being used in a malicious way (e.g. PowerShell). This feature frustrates hacking attempts that may not involve any formal installation procedures.

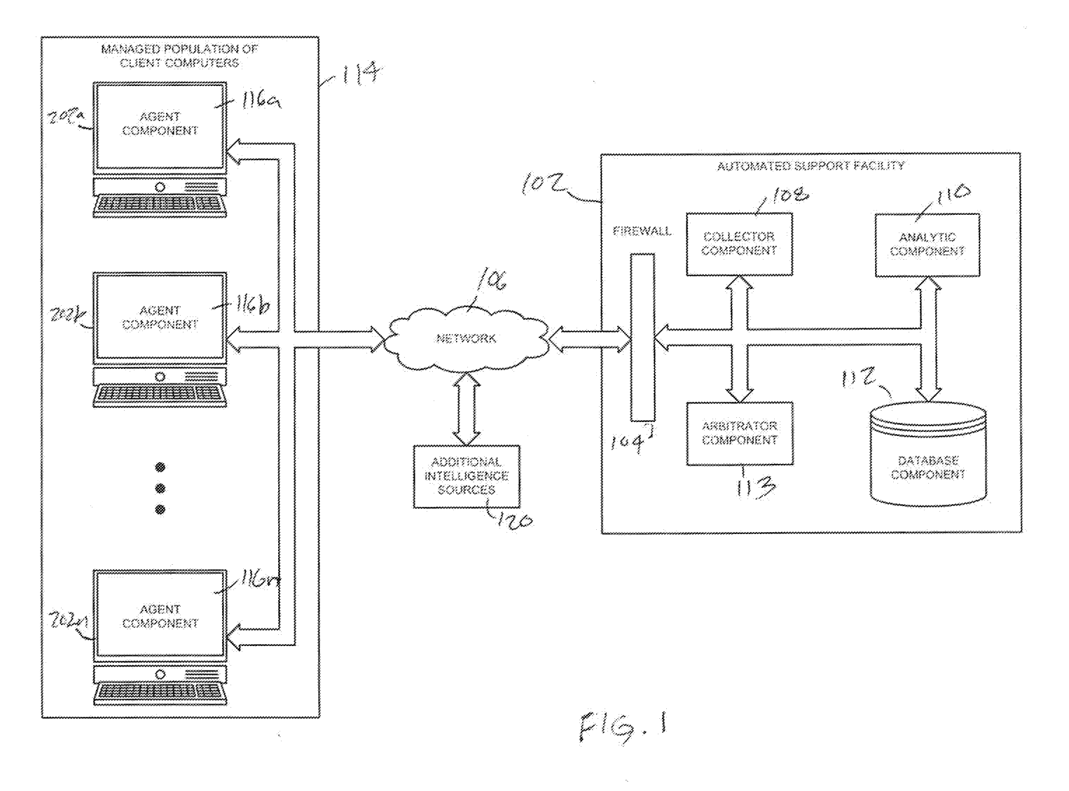

Referring now to the drawings in which like numerals indicate like elements throughout the figures, FIG. 1 is a block diagram illustrating an exemplary environment in which an embodiment of the present invention may operate. The illustrated environment includes a managed population 114 of client computers 202a-202n, representatively referred to herein as client computer(s) 202, and an automated support facility 102 interconnected through a communications network 106. Automated support facility 102 cooperatively operates with agent components 116a-116b, representatively referred to herein as agent component(s) 116, on each client computer 202 to mitigate security risks and to prevent information breaches of any of the client computers 202 based on data collected from the population 114 of computers as a whole. It is to be understood that while automated support facility 102 is illustrated in FIG. 1 as a single entity, it may implemented through resources at multiple facilities. Alternatively, automated support facility 102 may be collocated with the managed population 114 of computers.

As illustrated in FIG. 1, the resources of automated support facility 102 may be located behind a firewall 104 to provide perimeter data security for the automated support facility 102. The present invention is not limited to particular firewall implementations; those having skill in the art will recognize numerous perimeter security techniques that can be utilized with embodiments of the present invention without departing from the spirit and intended scope thereof.

Automated support facility 102 may include a collector component 108, by which data are transferred into and out of automated support facility 102. Such transfer may be compliant with a standard protocol, such as file transfer protocol (FTP), hypertext transfer protocol (HTTP), and/or other communication protocols including proprietary implementations. Collector component 108 may also include processing logic by which data are down- and uploaded, encoded/decoded, compressed/decompressed, and parsed.

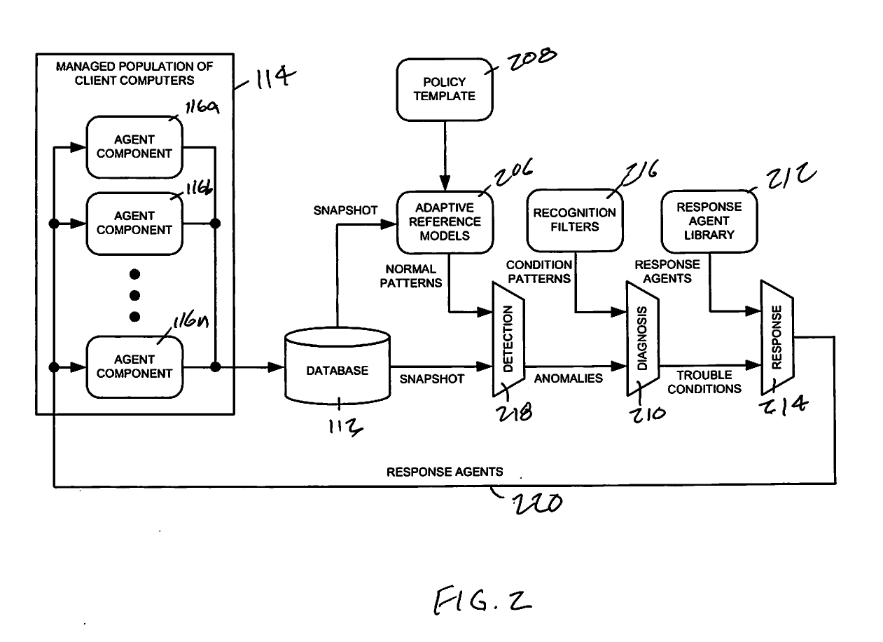

Automated support facility 102 may also include an analytic component 110 by which one or more “adaptive reference models,” illustrated in FIG. 2 as adaptive reference models 206, are constructed and maintained. Adaptive reference models 206, which are briefly discussed below and described in detail in the '956 patent, provide a reference baseline against which anomalous behavior in any of the client computers 202 is detected and/or characterized. Analytic component 110 may obtain adaptive reference models 206 and “snapshots” (discussed below) from database component 112, may analyze snapshot data in the context of a reference model, may identify and/or filter anomalies, and may transmit response agent(s) 220 (discussed below) when appropriate. Analytic component 110 may also provide a user interface for the system.

Database component 112 in automated support facility 102 provides storage in automated support facility 102 for adaptive reference model(s) 206, other data and/or computer-executable instructions as needed for the particular implementation of the present invention. The present invention is not limited to particular databases; the skilled artisan can construct a database suitable to the implementation requirements.

Arbitrator component 113 may be included in automated support facility 102 for seeking various assets located on one managed computer 202 and providing those assets to another of the managed computers 202. Such assets can be used as corrective data by which uncompromised data on the first computer 202 is supplied to the other computer 202 to replace corresponding corrupt data. This functionality is described in detail in the '087 patent.

It is to be understood that while FIG. 1 depicts only one collector component 108, one analytic component 110, one arbitrator component 113 and one database component 112, the present invention is not so limited. Those skilled in the art will appreciate that other possible embodiments may include many such components, networked together and/or operating in parallel as appropriate. Additionally, while only three computers 202 are illustrated in FIG. 1, embodiments of the present invention may operate in the context of computer networks having hundreds, thousands or even more client computers 116.

Managed population 114 provides data to the automated support facility 102 via the network 106 using respective agent components 202. Agent component 202 may be deployed within each monitored computer 202 and may be configured or rendered otherwise operable to gather data from its respective computer. Agent component 202, at scheduled intervals (e.g., once per day) or in response to a command from analytic component 110, obtains a detailed “snapshot” of the state of the machine in which it resides. This snapshot may include a detailed examination of all system files, designated application files, the registry, performance counters, processes, services, communication ports, hardware configuration, and log files. The results of each scan, referred to as the “snapshot,” are then (optionally) compressed and transmitted to collector component 108 and/or database component 112.

Additionally, agent component 202 is preferably configured to transmit, e.g., over network 106 and thus potentially to all client computers 116, requests for corrective data that can be used to replace corrupt data or that can be used to complete missing data on the computer in which the agent component 202 resides, e.g., complete a portion of a missing file. In one embodiment, a request for corrective data (also referred to herein as an “asset”) is directed not to all computers, but instead to an arbitrator component 113, which is shown as being interconnected within automated support facility 102, but may alternatively be implemented as another computer 116 that is in communication with network 106.

As illustrated in FIG. 1, environment 100 may include additional intelligence sources 120 that may be accessed by automated support facility 102 through network 106. Additional intelligence sources 120 may include external servers maintained by various entities in network security, e.g., antivirus and malware security service providers, network forensics providers, threat/risk analysis providers, etc. Information obtained from additional intelligence sources 120 may be provided to automated support facility 102 as intelligence feeds, which can be used to maintain the most up-to-date network security information.

For example, during an active scan before or during runtime or upon thread launch, the set containing all executable modules currently loaded in each process, as well as all registry keys and files corresponding to handles open by the process are monitored and their corresponding parameters are recorded. Parameters such as the size of the code, code or file hash, code segments, and associated libraries and communication links or pathways, and memory address space, can be monitored for changes in size and/or behaviors.

Each of the servers, computers, and network components shown in FIG. 1 comprise processors and computer-readable media. As is well known to those skilled in the art, an embodiment of the present invention may be configured in numerous ways by combining multiple functions into a single computer or alternatively, by utilizing multiple computers to perform a single task.

The processors utilized by embodiments of the present invention may include, for example, digital logic processors capable of processing input, executing algorithms, and generating output as necessary in support of processes according to the present invention. Such processors may include a microprocessor, an Application Specific Integrated Circuit (ASIC), and state machines. Such processors include, or may be in communication with, media, for example computer-readable media, which stores instructions that, when executed by the processor, cause the processor to perform the steps described herein.

Embodiments of computer-readable media include, but are not limited to, an electronic, optical, magnetic, or other storage or transmission device capable of providing a processor, such as the processor in communication with a touch-sensitive input device, with computer-readable instructions. Other examples of suitable media include, but are not limited to, a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C#, C++, Visual Basic, Java, and JavaScript.

The present invention combines prior knowledge with continuous monitoring to allow process control decisions to be made as soon as a threat can be reliably detected. This means that a process may be prevented from running or may be allowed to run and then subsequently terminated based on an accumulation of evidence regarding its actions and probable intent. For the purposes of this discussion, a process control action that prevents an executable file from running shall be called “process blocking.” A process control action that stops an existing process shall be called “process termination.”

FIG. 2 is a block diagram illustrating exemplary information flow and associated actions in one embodiment of the present invention. The embodiment shown comprises an agent component 202 that is deployed within each monitored computer. Agent component 202 may run as a service or other background process on the corresponding computer being monitored.

Agent component 202 is responsible for gathering data about the client computer 202 in which it executes. For example, agent component 202 may perform an extensive scan of client computer 202 at scheduled intervals, in response to a command from analytic component 110, or in response to events of interest. Such scan may include a detailed examination of all system files, designated application files, the registry, performance counters, hardware configuration, logs, running tasks, services, network connections, and other relevant data. The results of each scan are compressed and transmitted over network 106 in the form of a “snapshot” to the collector component 108.

In one embodiment, agent component 202 reads every byte of selected files to be examined and creates a digital signature or hash for each file. The digital signature identifies the exact contents of each file rather than simply collecting file metadata, e.g., file size and creation date. Some malware change file header information to hide in systems that rely only on metadata for detection and embodiments of the invention detect such subterfuge.

The scan of each client by respective agent components 202 may be resource intensive. Accordingly, certain embodiments implement a calendar/clock for scheduling full scans and other activities. When so embodied, full scans may be performed periodically, e.g., daily, during a time when the client machine is idle. Additionally, agent component 202 may perform a delta-scan of the client machine, logging only the changes from the last scan. Scans by agent component 202 may also be executed on demand, such as for diagnosing specific incidences of anomalous behavior on the client machine.

Agent component 202 is also responsible for taking action at the corresponding client computer 202 in response to various system states, e.g., anomalous and/or malicious behavior. Agent component 202 may continuously monitor key system resources, such as system files, registry keys, etc. and selectively block access to those resources in real time responsive to detecting malicious activities. This is referred to herein as behavior blocking.

Agent component 202 also provides an execution environment for response agents 202. Response agents 202 are software components that implement automated procedures to address various types of trouble conditions. For example, if analytic component 110 in automated support facility 102 suspects the presence of a virus, a suitable response agent 202 may be dispatched to the affected client computer(s) 202, which then executes in the corresponding agent component 116 to prevent the virus from accessing key information resources within the managed system. Response agents 220 may be maintained in a response agent library 212, which allows the service provider to author and store automated responses for specific trouble conditions. These automated responses are constructed from a collection of scripts that can be dispatched to a managed machine to perform actions like replacing a file or changing a registry value. Once a trouble condition has been analyzed and a response agent has been defined, any subsequent occurrence of the same trouble condition may be corrected automatically.

The embodiment illustrated in FIG. 2 includes an adaptive reference model component 206. One technical challenge in building an automated support product is the creation of a reference model that can be used to distinguish between normal and abnormal system states. The system state of a modern computer is determined by many multi-valued variables and consequently there are a very large number of possibilities. Moreover, these variables change frequently as different processes are executed, as new software updates are deployed, as end users communicate, etc. Adaptive reference model component 206 can define a baseline model as such changes occur.

Adaptive reference model component 206 may analyze snapshots from many computers in the managed population 114 to identify statistically significant patterns. This may be achieved by, for example, various data mining techniques. Adaptive reference model component 206 constructs a rich set of rules in accordance with the snapshot analysis, which may then be customized to the unique characteristics of the managed population. In certain embodiments, building a reference model is completely automatic and can be executed periodically to allow the model to adapt to desirable changes such as the planned deployment of a software update.

Since the validity of adaptive reference model 206 is based on statistically significant patterns from a population of machines, certain embodiments prefer a minimum number of client computers 202, e.g., 50, to ensure the accuracy of the statistical measures. Once a reference model is established, samples from individual managed client computers 202 are weighed against the reference model to determine whether any of the machines is in an abnormal or anomalous state.

In one embodiment, analytic component 110 calculates a set of maturity metrics that enable the user to determine when a sufficient number of samples have been accumulated to provide accurate analysis. These maturity metrics indicate the percentage of available relationships at each level of the model that have met predefined criteria corresponding to various levels of confidence (e.g. High, Medium, and Low). In one such embodiment, the metrics are monitored to ensure that a sufficient number of snapshots have been assimilated to create a mature model. In another such embodiment, analytic component 110 assimilates samples until it reaches a predefined maturity goal set by the user.

A policy template component 208 allows a service provider to insert predefined rules into adaptive reference model 206 in the form of “policies.” Policies are combinations of attributes (files, registry keys, etc.) and values that when applied to a model, override a portion of the statistically generated information in the model. This mechanism can be used to automate a variety of common maintenance activities such as verifying compliance to security policies and checking to ensure that the appropriate software updates have been installed.

When a computer exhibits anomalous behavior, it often impacts a number of different information assets (files, registry keys, etc.). For example, Trojan malware might install malicious files and/or add certain registry keys that opens one or more communication ports for communication with a malicious party. The embodiment shown in FIG. 2 detects these undesirable changes as anomalies by comparing the snapshot obtained from the infected machine with adaptive reference model 206. An anomaly may be an unexpectedly present asset, an unexpectedly absent asset, an asset in an unknown or unexpected state, etc.

Anomalies are matched against a library of recognition filters 216, each of which identifying a particular effect or a class of effects caused by a particular pattern of anomalies specified in the corresponding recognition filter 216. Recognition filters 216 may also associate effects or conditions with a severity indication, a textual description, and/or a link to a corresponding response agent. In another embodiment, a recognition filter 216 can be used to identify and interpret benign anomalies. For example, if a user adds a new application that the administrator is confident will not cause any problems, the system according to the present invention will still report the new application as a set of anomalies. If the application is new, then reporting the assets that it adds as anomalies is correct. However, the administrator can use a recognition filter 216 to interpret the anomalies produced by adding the application as benign.

In an embodiment of the present invention, certain attributes relate to continuous processes for which performance data can be obtained through various counters. These counters measure the occurrence of various events over a particular time period. To determine if the value of such a counter is normal across a population, one embodiment of the present invention computes a mean and standard deviation. An anomaly is declared if the value of the counter falls more than a certain number of standard deviations away from the mean.

In another embodiment, a mechanism handles the case in which the adaptive reference model 206 assimilates a snapshot containing an anomaly. Once a model achieves the desired maturity level it undergoes a process that removes anomalies that may have been assimilated. These anomalies are visible in a mature model as isolated exceptions to strong relationships. For example, if file A appears in conjunction with file B in 999 machines but in 1 machine file A is present but file B is missing, the process will assume that the later relationship is anomalous and it will be removed from the model. When the model is subsequently used for checking, any machine containing file A, but not file B, will be flagged as anomalous.

As illustrated in FIG. 2, agent component 202 may periodically obtain a snapshot of the managed population 114. Obtaining snapshots involves collecting a massive amount of data and can require anywhere from a few minutes to hours to execute, depending on the configuration of client computer 202. When the data collection is complete, the results are compressed, formatted, and transmitted in the form of a snapshot to a secure server, e.g., collector component 108. Collector component 108 acts as a central repository for all of the snapshots being submitted from managed population 114. Incoming snapshots are decompressed, parsed, and stored in various tables in database 112.

Detection component 218 uses the data stored in the adaptive reference model component 206 to check the contents of the snapshot against hundreds of thousands of statistically relevant relationships that are known to be normal for that managed population 114. If an anomaly is found by way of this comparison, recognition filters 216 are consulted through diagnosis component 210 to determine if the anomaly matches any known conditions. If such a match is identified, the anomaly is reported according to the condition that has been diagnosed. Otherwise, the anomaly is reported as an unrecognized anomaly. Recognition filter 216 also indicates whether an automated response has been authorized for that particular type of condition.

In one embodiment, recognition filters 216 can recognize and consolidate multiple anomalies. The process of matching recognition filters 216 to anomalies is performed after the entire snapshot has been analyzed and all anomalies associated with that snapshot have been detected. If a match is found between a subset of anomalies and a recognition filter 216, the name of the recognition filter 216 will be associated with the subset of anomalies in an output stream. For example, the presence of a virus might generate a set of file anomalies, process anomalies, and registry anomalies. A recognition filter 216 could be used to consolidate these anomalies so that the user would simply see a descriptive name relating all the anomalies to a likely common cause, i.e. a virus.

If automated response has been authorized, a response agent 220 is obtained from response agent library 212, which is transmitted to the affected client computer 202. The corresponding agent component 202 executes the response agent 220 to correct the trouble condition.

The process environment described with reference to FIGS. 1 and 2 are described in detail in the reference system documentation. Although the present invention is described in the environmental context of the reference system documentation, those skilled in the art will appreciate that aspects of the present invention can be used independently of the systems and methods described therein. On the other hand, the granularity of computer problem/anomaly detection that is made possible by the systems and methods described in the '956 application, as well as the benefits of the problem remediation techniques described in the '087 patent and thread execution anomaly detection techniques described in the '331 patent are believed beneficial to realizing the embodiments of the present invention described herein.

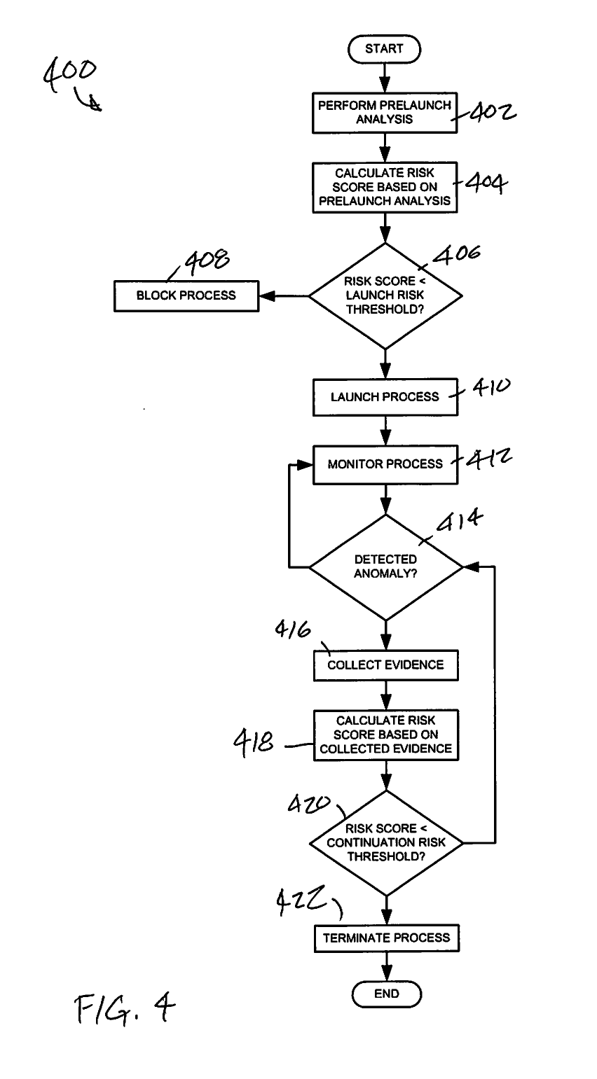

Referring now to FIG. 4, an operational and information flow diagram is presented, particularly from the prospective of a client computer 202 and its resident agent component 116. In the illustrated embodiment, file analysis component 310 performs pre-execution risk analyses on an executable file 301. Agent component 202 may perform runtime dependency analysis by which, for each runtime process, the set containing all executable modules currently loaded in each process is generated, as well as all registry keys and files corresponding to process open handles. Static dependency analysis analyzes files containing executable code and finds modules that would be loaded if the modules were to actually be executed. Static analysis involves examination of the executable file and the DLLs that the executable imports, and produces a set of all referenced executable modules. The contents of the process memory and the open handles are scanned for any embedded product IDs or unique identifiers such as globally unique identifiers (GUIDs) or universally unique identifiers (UUIDs). The set of new unique identifiers are used to find any other related assets, such as files or registry keys not already in the scan scope containing these identifiers. This set of new items will be the input for further static dependency analysis and the foregoing operations may be repeated until no new items are added to the scan scope.

Prior to a file being loaded for execution, an initial risk score 334 for the file may be computed. If risk score 334 exceeds a launch risk threshold 332 that a particular organization has established, then a process blocking action 340 is performed to prevent file 301 from executing. File analysis component 310 may use several risk assessment techniques to formulate a risk score 334 for executable file 301 prior to execution. For example, file analysis component 310 may perform static file analysis by which the manner in which executable file 301 is constructed is analyzed, which can provide valuable evidence as to the intended purpose of the file and more importantly the corresponding process.

Assuming that it is possible for agent component 202 to communicate with the automated support facility 102, the prevalence of a particular file in managed population 114 can be assessed. If file 301 is prevalent, agent component 202 may assign a lower risk score since it would then be likely that file 301 is that of an authorized application. On the other hand, if file 301 is rare within managed population 114, then file analysis component 310 may assign a higher value to risk score 334.

File analysis component 210 may also utilize explicit prior knowledge when assessing file 301 for threats. For example, automated support facility 102 may periodically provide agent component 202 with blacklist and whitelist information, as well as intelligence garnered from available threat intelligence feeds, such as from intelligence sources 120.

If file 301 can be safely executed, a process 350 is instantiated at which time it may be assigned a risk score 336. In certain embodiments, risk score 336 is set initially to risk score 334 formulated by file analysis component 310. As process 350 runs, risk score 336 may be updated as new information about process 350 is accumulated. If risk score 336 for a particular process 350 exceeds a preconfigured continued execution risk threshold 338, then the agent component 202 may perform a process termination action 345.

It is to be understood that a process 350 may originate from a perfectly legitimate executable file 301, but can compromised during its execution. Indeed, even a file 301 that has been whitelisted can produce a process 350 that requires termination. Additionally, information about the originating file 301 may be received after the decision to execute the underlying process has been made. If file 301 is blacklisted, then any processes 350 that were launched from that file and that remain running need to be terminated.

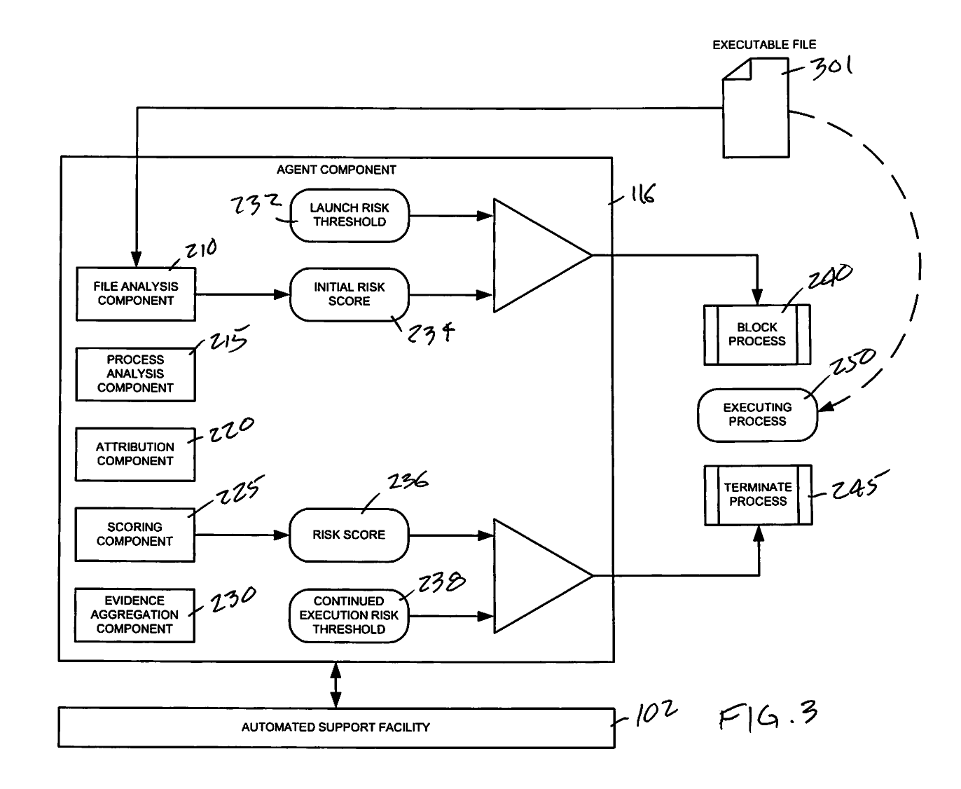

As illustrated in FIG. 3, agent component 202 may implement several functional components that cooperate to make process execution control decisions. Process monitor component 315 determines whether the corresponding client computer 202 is exhibiting an anomalous condition or state. Such detection may be carried out in a manner similar to that described in the reference system documentation. It is to be understood that an anomalous condition, as used herein, is not necessarily an indication of a compromised computer 202. However, certain anomalous conditions may trigger process analysis tasks to assess the risk of continued execution of one or more processes on that computer 202.

An anomalous condition may be detected through objects that are affected by multiple executing processes. In certain embodiments, related incidents occur and relationships among anomalous objects are correlated. Attribution component 320 determines what changes occur in important objects in response to particular processes to assist in identifying which process or processes is causing the anomalous condition. The present invention is not limited to a particular technique by which object changes are attributed to particular processes. In one embodiment, various system calls may be hooked to determine which process is responsible for adding/changing an object.

Evidence aggregation component 330 collects evidence regarding the process 350 and the environment in which it executes from system behaviors, threat intelligence, etc. so that scoring component 325 can update risk score 336 appropriately. The present invention is neither limited to particular evidence gathering techniques nor to what evidence is gathered. Example evidence includes evidence of remote DLL injection, remote code injection, reflective DLL injection, or hollow process injection. These techniques are typical of malware code that is attempting to hide within a legitimate process. Under such circumstances, it is appropriate for the process control function to terminate the infected process. Sometimes malware applications may inject themselves into another process and then escalate the privileges for that process to enable additional activities. Evidence of malicious intent is also indicated by rootkit techniques, e.g., processes that modify user mode and/or kernel mode data structures to hide their presence and activities. There may be evidence that a process is communicating over the network and/or evidence that a process has created objects to enable persistence across a reboot. The latter includes file and registry key objects such as those detected by generic filters and anomalous applications. Impairment is also evidence of malicious intent, i.e., by a process that has altered objects to degrade the security posture of an endpoint or adversely affect normal business use. There may be self-defense evidence, by which a process has created or altered objects in an effort to prevent the removal of malware assets. Stealth evidence indicates that a process has created or altered objects in an effort to prevent the detection of malware assets. There may be evidence that a process has created or altered objects to facilitate information gathering. In addition to evidence of malware, the evidence aggregation component may also identify legitimate or authorized reasons as to the source of the anomalous condition.

Scoring component 325 updates risk score 336 based on evidence gathered for processes 350 that are determined to bear on the anomalous condition. Scoring component 325 may implement deterministic and/or predictive logic that increases or decreases risk score 336 by an amount based on whether the associated process exhibits malicious intent.

Process monitor component 315, attribution component 320, evidence aggregation component 330 and scoring component 325 cooperate and have sufficient state determining and/or sensing capability to make the best process launch and termination decisions possible based on available knowledge gathered thereby. Suitable state machines or similar constructs based on modeled behavior may be implemented to ameliorate any false positives and false negatives.

FIG. 4 is a diagram illustrating process flow 400 of an exemplary embodiment of the present invention. It is to be understood that the flow diagram is but one representation of the illustrated embodiment; multiple other representations, e.g., state diagrams may also be used to explain the same operations. Additionally, the operations illustrated in FIG. 4 are depicted and described as occurring in a particular sequence for purposes of explanation and not limitation. Those having skill in the computing arts will recognize other sequences in which the illustrated operations can be performed without significant impact to the overall process 400. It will also be appreciated by skilled technicians that operations illustrated in FIG. 4 can be combined with or separated from other operations for efficiency and/or ease of implementation.

Prior to launching a process in a client computer 202, prelaunch analysis may be performed on the associated executable file in operation 402. As a file is being loaded for execution (but before the process is actually allowed to run), a risk score for the file shall be evaluated. If the risk score exceeds a launch risk threshold that a particular organization has established, then a process blocking action shall be performed to prevent the file from executing. Some examples of information that could be used to formulate a risk score for an executable file prior to execution include results of static file analysis, prevalence of the executable file in the environment and through explicit prior knowledge.

The manner in which an executable file is constructed can provide valuable evidence as to its purpose. For example, it is common for malware files to be packed in a way that obfuscates the contents of the file. Static analysis on each executable file identifies anomalous file content and the results of this analysis may be reflected in the risk score for that file.

Assuming it is possible for agent component 116 to communicate with automated support facility 102, the prevalence of a file in the environment may be assessed. If the file is prevalent, then it is likely an authorized application. On the other hand, if the file is rare, then the providence of that file may be suspect and should carry a higher risk.

Automated support facility 102 may periodically provide agent components 116 with intelligence feed information, e.g., blacklist and whitelist information. The file's risk score may reflect the manner in which the executable is rated on these lists.

In operation 404, a risk score is computed based on the results of the prelaunch analysis and, in operation 406, it is determined whether the computed risk score is below a launch risk threshold. If so, the process is launched in operation 408 and begins executing. Otherwise, process 400 transitions to operation 410, by which the process is prevented from executing, i.e., blocked.

In operation 412, the executing process is monitored and in operation 414, it is determined whether an anomaly occurs. As discussed above, operation 414 may include a comparison of snapshot samples against adaptive reference model 206. If an anomaly is detected, evidence as to whether the anomalously-executing process is actually malicious is collected in operation 416. As indicated above, the following conditions are examples of such evidence:

Code injection—Evidence of remote DLL injection, remote code injection, reflective DLL injection, or hollow process injection. These techniques indicate the presence of malware code that is attempting to hide within a legitimate process. Under such circumstances, it is appropriate for the process control function to terminate the infected process.

Privilege escalation—Sometimes malware applications inject themselves into another process and then escalate the privileges for that process to enable additional activities.

Rootkit techniques—Evidence of a process that modifies user mode and/or kernel mode data structures to hide its presence and activities.

Network connections—Evidence that a process is communicating over the network.

Persistence—Evidence that a process has created objects to enable persistence across a reboot. This includes file and registry key objects such as those detected by generic filters and Anomalous Applications.

Impairment—Evidence that a process has altered objects that degrade the security posture of an endpoint or adversely affect normal business use.

Self Defense—Evidence that a process has created or altered objects in an effort to prevent the removal of malware assets.

Stealth—Evidence that a process has created or altered objects in an effort to prevent the detection of malware assets.

Information—Evidence that a process has created or altered objects to facilitate information gathering.

Once a process is instantiated, it may be assigned an initial risk score based on the risk score for the originating executable, i.e., that calculated in operation 404. As the process runs, this risk score may be updated as new information about the process is accumulated. In operation 418, the risk score is calculated based on the evidence collected in operation 416. The risk score may be calculated through knowledge of how each item of evidence relates to the evolution of an anomalous condition into a malicious condition or threat. In certain implementations, the calculation of the risk score is non-trivial due to, among other things, the interplay of executing processes and the anomalies that arise in the execution of those processes. Accordingly, various statistical data processing, machine learning and artificial intelligence may all be brought to bear in computing the risk score as the processes continue to execute. Various such techniques will become apparent to the skilled artisan upon review of this disclosure.

In operation 420, it is determined whether the risk score for a process exceeds a predetermined continued execution risk and, if so, the process is terminated in operation 422.

It is to be understood that a process originating from a perfectly legitimate executable file can subsequently become compromised. Thus, even a file that has been whitelisted can produce a process that requires termination. Also, information about the originating file may be received after the decision to execute the file is made. If a file is blacklisted, then any processes that launched from that file and are still executing should be terminated.

Certain embodiments of the present general inventive concept provide for the functional components to manufactured, transported, marketed and/or sold as processor instructions encoded on computer-readable media. The present general inventive concept, when so embodied, can be practiced regardless of the processing platform on which the processor instructions are executed and regardless of the manner by which the processor instructions are encoded on the computer-readable medium.

It is to be understood that the computer-readable medium described above may be any non-transitory medium on which the instructions may be encoded and then subsequently retrieved, decoded and executed by a processor, including electrical, magnetic and optical storage devices. Examples of non-transitory computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The processor instructions may be derived from algorithmic constructions in various programming languages that realize the present general inventive concept as exemplified by the embodiments described above.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. A method comprising:
monitoring one or more computer processes executing on a client computer for a condition that is anomalous relative to an adaptive reference model of the client computer;
gathering, responsive to affirming the anomalous condition, information regarding the anomalous condition as the processes continue to execute;
computing a risk score indicating a risk for continued execution of each of the processes based on the gathered information; and
terminating any of the processes in response to the corresponding risk score meeting a predetermined continued execution risk criterion.

2. The method of claim 1, wherein gathering the information includes collecting evidence indicating whether the process causing the anomalous condition is malicious.

3. The method of claim 2, wherein computing the risk score includes computing the risk score from the collected evidence relative to known characteristics of the client computer when compromised by a malicious process.

4. The method of claim 1 further comprising:
generating the adaptive reference model of the client computer from information collected from a set of client computers of which the client computer is a member.

5. The method of claim 3 further comprising:
determining whether the anomalous condition exists by comparing a set of operational states of the client computer with expected operational states represented in the adaptive reference model.

6. The method of claim 1 further comprising:
launching each of the processes on the client computer only in response to affirming that another score indicating a risk of executing the corresponding processes meets a predetermined launch risk criterion.

7. An apparatus comprising:
one or more processors configured to:
monitor one or more computer processes executing on a client computer for a condition that is anomalous relative to an adaptive reference model of the client computer;
gather, responsive to affirming the anomalous condition, information regarding the anomalous condition as the processes continue to execute;
compute a risk score indicating a risk for continued execution of each of the processes based on the gathered information; and
terminate any of the processes in response to the corresponding risk score meeting a predetermined continued execution risk criterion.

8. The apparatus of claim 7, wherein the one or more processors are further configured to:
gather the information includes collecting evidence indicating whether the process causing the anomalous condition is malicious.

9. The apparatus of claim 8, wherein the one or more processors are further configured to:
compute the risk score from the collected evidence relative to known characteristics of the client computer when compromised by a malicious process.

10. The apparatus of claim 7, wherein the one or more processors are further configured to:
generate the adaptive reference model of the client computer from information collected from a set of client computers of which the client computer is a member.

11. The apparatus of claim 7, wherein the one or more processors are further configured to:
determine whether the anomalous condition exists by comparing a set of operational states of the client computer with expected operational states represented in the adaptive reference model.

12. The apparatus of claim 7, wherein the one or more processors are further configured to:
launch each of the processes on the client computer only in response to affirming that another score indicating a risk of executing the corresponding processes meets a predetermined launch risk criterion.

13. A tangible, non-transient computer-readable medium having processor instructions encoded thereon that, when executed by one or more processors, configures the one or more processors to:
monitor one or more computer processes executing on a client computer for a condition that is anomalous relative to an adaptive reference model of the client computer;
gather, responsive to affirming the anomalous condition, information regarding the anomalous condition as the processes continue to execute;
compute a risk score indicating a risk for continued execution of each of the processes based on the gathered information; and
terminate any of the processes in response to the corresponding risk score meeting a predetermined continued execution risk criterion.

14. The computer-readable medium of claim 13 including additional instructions that configures the one or more processors to:
gather the information includes collecting evidence indicating whether the process causing the anomalous condition is malicious.

15. The computer-readable medium of claim 14 including additional instructions that configures the one or more processors to:
compute the risk score from the collected evidence relative to known characteristics of the client computer when compromised by a malicious process.

16. The computer-readable medium of claim 13 including additional instructions that configures the one or more processors to:
generate the adaptive reference model of the client computer from information collected from a set of client computers of which the client computer is a member.

17. The computer-readable medium of claim 13 including additional instructions that configures the one or more processors to:
determine whether the anomalous condition exists by comparing a set of operational states of the client computer with expected operational states represented in the adaptive reference model.

18. The computer-readable medium of claim 13 including additional instructions that configures the one or more processors to:
launch each of the processes on the client computer only in response to affirming that another score indicating a risk of executing the corresponding processes meets a predetermined launch risk criterion.
